(19) United States
(12) Patent Application Publication
(10) Pub. No.: US 2008/0167084 A1
(43) Pub. Date: Jul. 10, 2008

(54) METHOD AND DEVICE FOR DISPLAYING INFORMATION IN MOBILE COMMUNICATION TERMINAL

(75) Inventors: Seok Gon LEE, Gumi-si (KR); Soon Jin KIM, Daegu Metropolitan City (KR); Jae-Gon SON, Daegu Metropolitan City (KR); Ki-Tae KIM, Gumi-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/854,281

(22) Filed: Sep. 12, 2007

(30) Foreign Application Priority Data
Jan. 5, 2007 (KR) 10-2007-0001248

(51) Int. Cl. H04B 1/38

(52) U.S. Cl. 455/566

(57) ABSTRACT

A method of displaying information in a mobile communication terminal includes receiving a message, determining whether contact information corresponding to the message is stored in a phone book, and displaying the received message using a font corresponding to the contact information if the contact information is stored in the phone book.

### CROSS REFERENCE TO RELATED APPLICATION

This application claims priority from and the benefit of Korean Patent Application No. 10-2007-0001248, filed on Jan. 5, 2007, which is hereby incorporated by reference for all purposes as if fully set forth herein.

### BACKGROUND OF THE INVENTION

1. Field of the Invention

The present invention relates to a method and device for changing a font in a mobile communication terminal, and more particularly, to a method and device that may display a received message using a set font and perform a function using the set font at a set time.

2. Discussion of the Background

Mobile communication terminals function as information processing appliances and therefore perform and display several kinds of functions. Conventional mobile communication terminals may perform and display the functions using a font set by the manufacturing company.

A mobile communication terminal that has several different fonts and enables a user to select a desired font has been launched. This type of mobile communication terminal may receive a font from a server or PC connected to a mobile communication network and may change an existing font to the received font or additionally store the received font as a new font. Accordingly, the user may select a font received in the mobile communication terminal through a mobile communication network or may select a font provided in the mobile communication terminal.

However, when a font received through a mobile communication network or a font provided in the mobile communication terminal is used, functions in the mobile communication terminal are displayed using only the selected font.

### SUMMARY OF THE INVENTION

The present invention provides a method and device for changing a font in a mobile communication terminal that may effectively use a font received or provided in the mobile communication terminal.

The present invention further provides a method and device for changing a font in a mobile communication terminal that may display a received message using a font that is designated for a group or a person.

The present invention further provides a method and device for changing a font in a mobile communication terminal that may perform a function using a set font at a set time.

Additional features of the invention will be set forth in the description which follows, and in part will be apparent from the description, or may be learned by practice of the invention.

The present invention discloses a method of displaying information in a mobile communication terminal including receiving a message, determining whether contact information corresponding to the message is stored in a phone book, and displaying the received message with a font corresponding to the contact information if the contact information is stored in the phone book.

The present invention also discloses a method of displaying information in a mobile communication terminal including setting a time, setting a font corresponding to the set time, checking the current time, changing a first font of displayed information to the set font when the current time is the set time, and displaying information using the set font.

The present invention also discloses a mobile communication terminal including a memory unit, a controller, and a display unit. The memory unit includes a phone book to store contact information including a font. The controller determines whether contact information corresponding to a received message is stored in the phone book and determines a first font of the received message to be the font corresponding to the contact information of the message if the contact information of the received message is stored in the phone book. The display unit displays the message using the font.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a mobile communication terminal for changing a font according to an exemplary embodiment of the present invention.

FIG. 2 is a flowchart showing a process of setting a font in a method of changing a font in a mobile communication terminal according to another exemplary embodiment of the present invention.

FIG. 3 is a flowchart showing a process of displaying a font in a method of changing a font in a mobile communication terminal according to another exemplary embodiment of the present invention.

FIG. 4 is a flowchart showing another process of displaying a font in a method of changing a font in a mobile communication terminal according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

The term “font” in exemplary embodiments of the present invention includes a group of characters having a size and character shape appropriate for a certain language and a preset size of spaces between characters that is applied when writing a sentence using the characters. In exemplary embodiments of the present invention, “font” refers to any and all characters of the corresponding group of symbols, for example, characters including numerals, Korean characters, Chinese characters, and Western alpha-numeric characters, displayed on a screen of a mobile communication terminal. “Contact information” refers to information, such as a phone number and a name stored in a phone book, and includes font information in exemplary embodiments of the present invention.

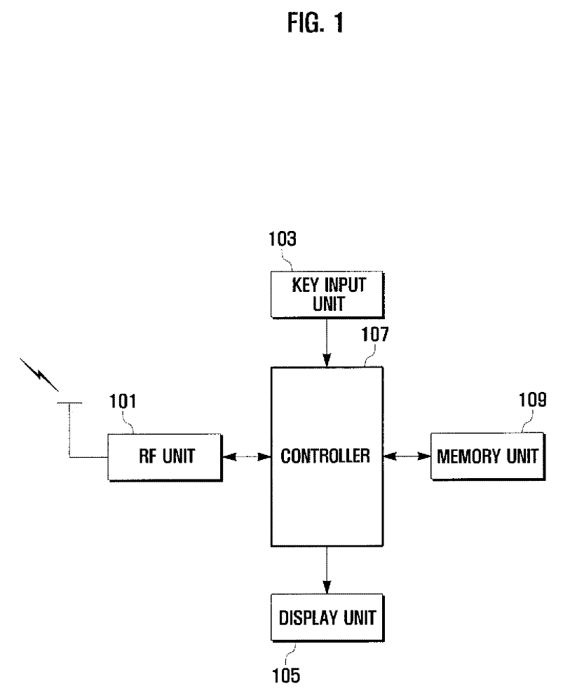

FIG. 1 is a block diagram showing a configuration of a mobile communication terminal for changing a font according to an exemplary embodiment of the present invention.

Referring to FIG. 1, the mobile communication terminal includes a radio frequency (RF) unit 101, a key input unit 103, a display unit 105, a controller 107, and a memory unit 109.

The RF unit 101 performs a wireless communication function of the mobile communication terminal. The RF unit 101 includes an RF transmitter to up-convert a frequency of a signal to be transmitted and amplify the signal and an RF receiver to low-noise amplify a received signal and down-convert a frequency thereof. The RF unit 101 transmits and receives a message through a mobile communication network. That is, the RF unit 101 may send a message to another terminal and may receive a message from another terminal.

The key input unit 103 receives a user's key input manipulation signal to control operation of the mobile communication terminal and outputs the manipulation signal to the controller 107. The key input unit 103 may be used to perform a manipulation, for example, to store contact information, to select specific contact information, to set a font, and to display a received message in a phone book function.

The display unit 105 displays data output by the controller 107. If a font corresponding to contact information of a sender of the received message is set in the mobile terminal when a message is received, the display unit 105 displays the received message with the set font. If no font is set for the contact information of a sender of the received message, the display unit 105 displays the received message with a default font.

The controller 107 controls general operations of the mobile communication terminal. The controller 107 controls a font change function. When a message is received, the controller 107 compares the contact information of a sender of the received message with contact information stored in the memory unit 109, and determines whether a font is set for the contact information of the sender of the received message. The controller 107 may designate a font for a group of contact information, selected by the user, to which later acquired contact information can also be designated, e.g. a family group, a friend group, and a company group. If a message is received from a caller for which a font is set, the controller 107 controls the display unit 105 to display the received message with the set font, and if a message is received from a caller for which no font is set, the controller 107 controls the display unit 105 to display the received message with a default font.

The memory unit 109 includes a program memory and a data memory. The memory unit 109 has a phone book function. A plurality of contact information is stored in the phone book. The contact information includes a phone number, a name, and a font. The memory unit 109 stores information about a plurality of fonts and font designations for each group.

A method of changing a font in a mobile communication terminal according to a present exemplary embodiment is described in detail hereinafter.

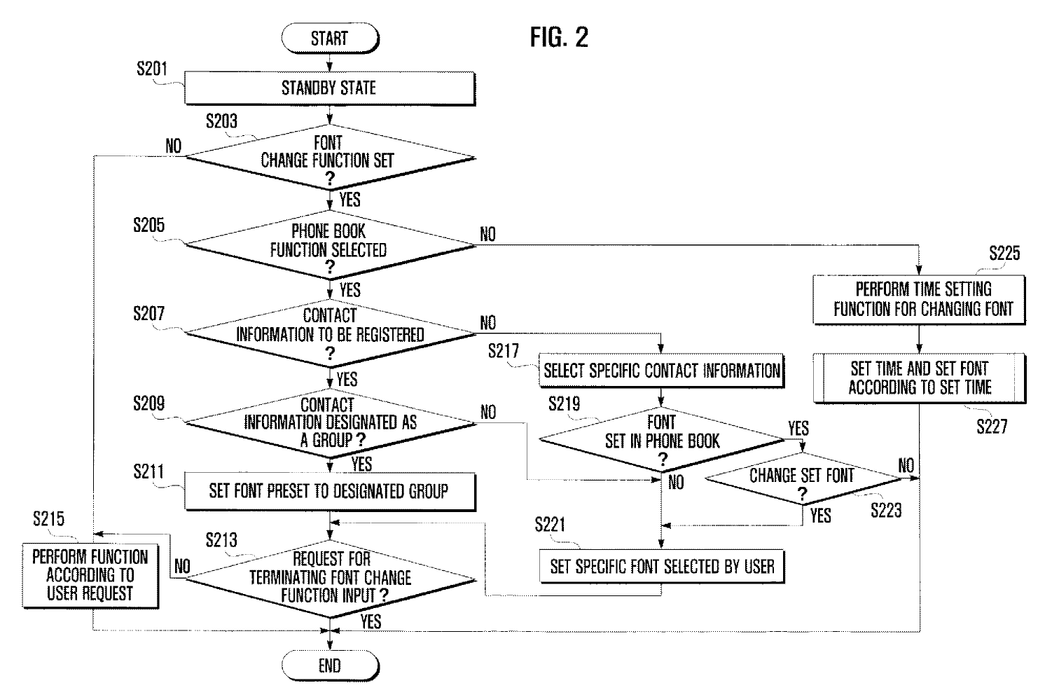

FIG. 2 is a flowchart showing a process of setting a font in a method of changing a font of a mobile communication terminal according to an exemplary embodiment of the present invention.

Referring to FIG. 1 and FIG. 2, when the mobile communication terminal is in a standby state (S201), the controller 107 determines whether a font change function is set in the mobile communication terminal (S203). If a font change function is not set in the mobile communication terminal, the controller 107 performs a function according to user request (S215).

If a font change function is set in the mobile communication terminal, the controller 107 determines whether a phone book function is selected by the user (S205). In the present exemplary embodiment, the user may set a font corresponding to a caller in a phone book function. The user can register contact information through the key input unit 103 by selecting a phone book function at step S205. If a phone book function is selected at step S205, i.e. if the process enters a contact information registration mode, the controller 107 determines whether contact information is to be registered (S207).

If contact information is to be registered, the controller 107 determines whether the contact information is to be designated as a group (S209). When the user registers contact information through the key input unit 103, the user can designate the contact information as a group. In the present exemplary embodiment, each group may be assigned a different font. For example, a family group may be assigned a ‘Courier New’ font, a friend group may be assigned an ‘Arial’ font, and a company group may be assigned a ‘Gothic’ font.

If the contact information is to be designated as a group, the controller 107 sets a font that the user selected for the designated group in the contact information (S211). When the user selects to register the contact information for a specific group at step S207, the font that was selected for the specified group is set in contact information. For example, if the user designates the contact information as a friend group when the user registers contact information, the ‘Arial’ font is designated in the contact information.

The controller 107 determines whether a request for terminating the font change function is input by the user (S213). If a request for terminating the font change function is input by the user, the controller 107 terminates the font change function. If a request for terminating the font change function is not input by the user, the controller 107 performs another function according to user request (S215).

If contact information is not designated for a group at step S209, the controller 107 sets a specific font selected by the user (S221). When the user registers contact information, the user can either designate a font for the group in the contact information through steps S209 and S211 or select and set a specific font through step S221.

Thereafter, the process continues at step S213.

If a user decides not to register contact information at step S207, specific contact information may be selected in a phone book by the user (S217). The user may select desired specific contact information through a phone book function using the key input unit 103. In this case, the user may set a font for a caller having contact information, such as a phone number and a name, in the phone book.

The controller 107 determines whether a font is set in the phone book (S219). The user checks whether a font is already set in the specific contact information selected at step S217.

If a font is not set in the phone book, the controller 107 sets a specific font selected by the user (S221). The user sets a desired font in the specific contact information selected at step S217.

If a font is set in the phone book at step S219, the controller 107 determines whether a signal for changing the set font is input (S223). Even if a font is selected for the specific contact information selected at step S217, the user may change the set font. If a signal to change the set font is input, the process continues at step S221.

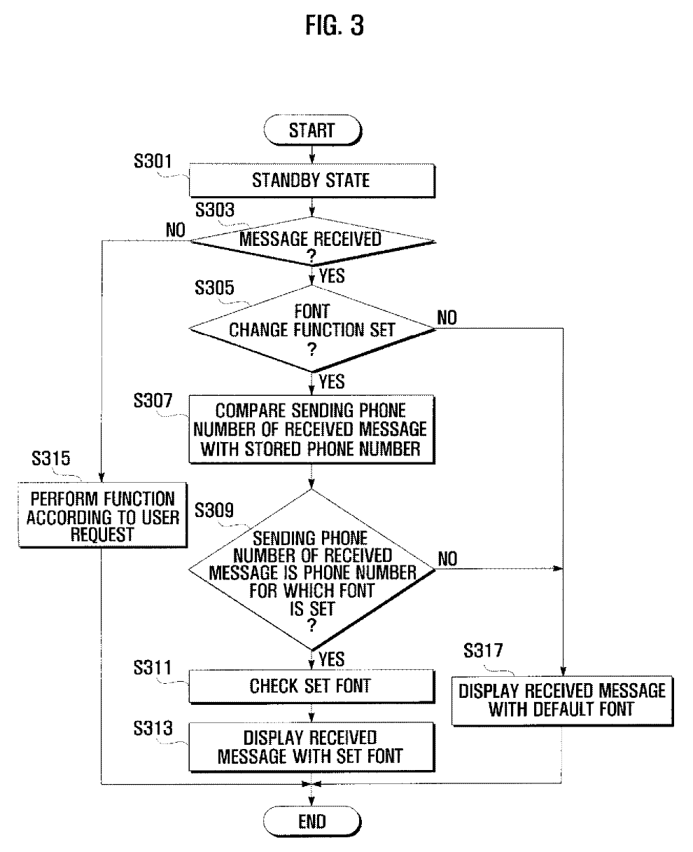

FIG. 3 is a flowchart showing a process of displaying a font in a method of changing a font in a mobile communication terminal according to another exemplary embodiment of the present invention.

Referring to FIG. 1 and FIG. 3, when the mobile communication terminal is in a standby state (S301), the controller 107 determines whether a message is received in the mobile communication terminal (S303). The controller 107 determines whether a message is received through the RF unit 101.

If a message is not received in the mobile communication terminal, the controller 107 performs a function according to user request (S315).

If a message is received in the mobile communication terminal, the controller 107 determines whether a font change function is set in the mobile communication terminal (S305).

If a font change function is not set, the controller 107 displays the received message with a default font (S317). The default font may be a font that is set in a manufacturing process of the mobile communication terminal, a font generally set in the mobile communication terminal, or a font that was last displayed on the display unit 105.

If a font change function is set in the mobile communication terminal, the controller 107 compares the contact information of the received message with stored contact information (S307). Specifically, the controller 107 compares the contact information of the received message with contact information stored in a phone book of the memory unit 109 to determine whether a font corresponding to the contact information of the received message is set.

The controller 107 determines whether a sending phone number of the received message is a phone number for which a font is set (S309). Specifically, the controller 107 determines whether the sending phone number of the received message is a phone number of a contact for whom a font is set in the phone book.

If a sending phone number of the received message is a phone number for which a font is set, the controller 107 checks the set font (S311) and displays the received message in the display unit 105 using the set font (S313).

If a sending phone number of the received message is not a phone number for which a font is set, the controller 107 displays the received message in the display unit 105 with a default font at step S317.

In a method and device for changing a font in the mobile communication terminal according to the present exemplary embodiment, a font is designated for each group or each person, and when a message is received, the received message is displayed with the font set for the sending phone number. Therefore, the user may identify which group or person has sent a message through the font of the received message, which may improve user convenience.

In the following description of a further exemplary embodiment, identical constituent elements or corresponding constituent elements to those of the previously described exemplary embodiment are omitted.

A method of changing a font in a mobile communication terminal according to the present exemplary embodiment is similar to that of the previous exemplary embodiment. However, the present exemplary embodiment is characterized in that a font is changed according to a set time.

Referring to FIG. 1, a time is set using the key input unit 103 and a font is changed according to the set time. The set time can be a specific time everyday or a specific day every week. For example, the set time may be the start of morning, afternoon, or evening, the start of every hour, the start of every day, or the start of every month. A font may be changed according to a set time.

The display unit 105 may display a performed function with a specific font and may display a performed function with a set font at a set time.

The controller 107 controls a font change function. The controller 107 checks the current time, and changes a font to a set font when the current time reaches a time set by the user and thereafter performs a function with the changed font.

The memory unit 109 stores set time information and font information corresponding to the set time.

A method of changing a font in the mobile communication terminal according to the present exemplary embodiment is described in detail hereinafter.

Referring to FIG. 1 and FIG. 2, when the mobile communication terminal is in a standby state (S201), the controller 107 determines whether a font change function is set in the mobile communication terminal (S203).

If a font change function is set in the mobile communication terminal, the controller 107 determines whether a phone book function is selected by the user (S205). If a phone book function is not selected by the user, the controller 107 performs a time setting function for changing a font (S225). The user may select a time setting function for changing a font at a set time.

The controller 107 sets a time and sets a font according to the set time (S227). The time may be set to a specific time every day or to a specific day every week, however is not limited thereto. For example, when a time is set to the start of every hour, the font may be set, e.g. to ‘Courier New’ from 9 o'clock to 10 o'clock, ‘Arial’ from 10 o'clock to 11 o'clock, and ‘Gothic’ from 11 o'clock to 12 o'clock.

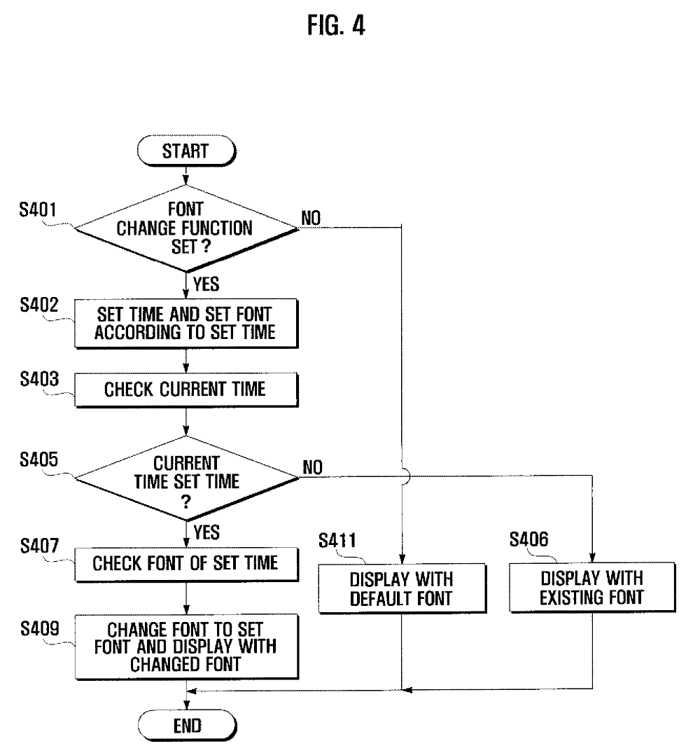

FIG. 4 is a flowchart showing another process of displaying a font in a method of changing a font in a mobile communication terminal according to another exemplary embodiment of the present invention.

Referring to FIG. 1, FIG. 2, and FIG. 4, the controller 107 determines whether a font change function is set in the mobile communication terminal (S401). If a font change function is set in the mobile communication terminal, the controller 107 sets a time and sets a font according to the set time (S402).

If a font change function is not set in the mobile communication terminal, the controller 107 controls the display unit 105 to display with a default font (S411). The default font may be a font that is set in a manufacturing process of the mobile communication terminal, a font generally set in the mobile communication terminal, or a font that was last displayed in the display unit 105.

The controller 107 checks the current time (S403) and determines whether the current time is the set time (S405). The set time is set at step S402, and in the present exemplary embodiment, the set time is the start of every hour. The controller 107 determines whether the current time is the set time, i.e., a time for changing a font.

If the current time is not a set time, the controller 107 uses an existing font on the display unit 105 (S406).

If the current time is a set time, the controller 107 checks which font is set corresponding to the set time (S407), changes the font to the set font, and displays using the changed font to display on the display unit 105 (S409).

For example, when the mobile communication terminal is in a standby state from 9 o'clock to 11 o'clock, the controller 107 displays a standby state using ‘Courier New’ from 9 o'clock to 10 o'clock and ‘Arial’ from 10 o'clock to 11 o'clock. When the mobile communication terminal performs a specific function, for example, displays a received message from 9:59 to 10:01, the font of the displayed message changes from ‘Courier New’ to ‘Arial’ at 10 o'clock, even during display of the message. The function includes all functions that may generally be performed in the mobile communication terminal, for example, the transmission and reception of a call, the transmission and reception of a message, a phone book, an Internet connection, and a standby state.

In a method of changing a font in the mobile communication terminal according to the present exemplary embodiment, a font may be changed to a set font at a set time, and a function may be performed using the changed font. Therefore, a function may be performed using various fonts, so that various effects may be provided to the user.

A method and device for changing a font in the mobile communication terminal according to the present invention are not limited to the above described exemplary embodiments and may be embodied in various forms by those skilled in the art.

The font in the exemplary embodiments is not limited to a font style, and may be, for example, a font color or a combination of a font color and a background color.

While first and second exemplary embodiments are described, two exemplary embodiments may be executed as a single exemplary embodiment. For example, when a message is received, the message may be displayed using a set font, the font may be changed according to a set time, and a function may be performed using the changed font while the message remains displayed with the previous font.

As described above, according to exemplary embodiments of the present invention, because a message may be displayed with a font that is designated for a group or a person, the group or person sending a message may be identified with only a font of the received message, which may improve user convenience.

Further, because a font may be changed to a set font at a set time and a function may be performed using the changed font, various effects may be provided to the user, so that user convenience may be improved.

*It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for displaying information in a mobile communication terminal, comprising:
receiving a message;
determining whether contact information corresponding to the message is stored in a phone book; and
displaying the received message using a font corresponding to the contact information if the contact information is stored in the phone book.

2. The method of claim 1, further comprising storing the contact information and storing the font corresponding to the contact information.

3. The method of claim 2, wherein storing the contact information and storing a font corresponding to the contact information comprises storing a contact as a group or a person.

4. The method of claim 2, further comprising:
setting a time to change the font to a changed font; and
displaying the message using the changed font at the set time.

5. The method of claim 4, wherein the set time is set to one of a specific time every day and a specific day every week.

6. A method for displaying information in a mobile communication terminal, comprising:
setting a time;
setting a font corresponding to the set time;
checking the current time; and
changing a font of displayed information to the set font when the current time is the set time.

7. The method of claim 6, wherein the set time is one of a specific time every day and a specific day every week.

8. A mobile communication terminal, comprising:
a memory unit comprising a phone book to store contact information including a font;
a controller to determine whether contact information corresponding to a received message is stored in the phone book and to determine the font of the received message to be the font corresponding to the contact information of the message if the contact information of the message is stored in the phone book; and
a display unit to display the message using the font.

9. The mobile communication terminal of claim 8, wherein the controller changes a font of displayed information to a font corresponding to a set time; and
wherein the memory unit stores the set time and stores the font corresponding to the set time.

10. The mobile communication terminal of claim 9, wherein the controller changes a font of functions stored in the memory unit to the font corresponding to the set specific time.
